(19) United States
(12) Patent Application Publication
(10) Pub. No.: US 2003/0236994 A1
(43) Pub. Date: Dec. 25, 2003

(54) System and method of verifying security best practices

(75) Inventors: Cy Cedar, Seattle, WA (US); Gary Paul Raden, Bellevue, WA (US); Neil S. Fishman, Bothell, WA (US); Luciano Passuello, Bellevue, WA (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: Microsoft Corporation, Redmond, WA

(21) Appl. No.: 10/177,038

(22) Filed: Jun. 21, 2002

(51) Int. Cl. H04L 9/00

(52) U.S. Cl. 713/200

(57) ABSTRACT

A system and method for verifying security best practices on a computer or for multiple computers on a network. A master test engine drives the verification process. The master test engine accesses a primary manifest data file which describes verification tests to be performed by each of the computers to be tested. To execute the tests within the primary manifest data file, one or more test executables are created. The text executables are run by local test engines which are located on each one of the computers on which tests are conducted. The local test engines drive the security tests on the computers, and access locally stored manifest data files, which are created and updated via the primary manifest data file.

### TECHNICAL FIELD OF THE INVENTION

The present invention generally relates to computers and computer systems, and more particularly to security management for a computer or computer systems.

### BACKGROUND OF THE INVENTION

Computer security, security vulnerability, and threats to computers are concerns not only to information technology professionals, but to anyone who uses a computer. The computers for most companies and many home users live with “always on” connections to the Internet, which expose the computers to the inherent risk of viruses, hackers, and denial of service attacks. Attacks from viruses in particular are on the rise, and are proving incredibly destructive to business productivity around the globe. Maintaining the security of systems connected to the Internet is a concern fundamental to doing business in the digital age.

Many software companies have developed a number of patches for their software applications to protect computer users from hackers and viruses. These patches may be downloaded or otherwise added to an operating system or applications on the user's computer. For security patches to be effective, a computer user must be aware of the patches, download the patches in a timely manner, and install them properly on the computer. Often, because of lack of knowledge or skills, or complacency about security, one or more of these steps will be skipped or done improperly by a user, causing the computer to not have the latest security patches.

In addition to security patches, there are a number of other security measures that are available in operating systems and applications to protect a user from hackers or viruses. These security measures may be, for example, setting high security levels for an Internet browser, disabling macros in word processor or spreadsheet programs, or enabling a firewall on a computer.

Security measures in an operating system or an application are effective only if the security features are turned on or are set to the proper setting, such as “high,” “medium,” or “medium-high.” Often, users do not know how to properly set the security features of their computer. Moreover, even if users do know how to set their security features, the users may be resident on a network, and a user-set security configuration may not meet the security standard for the network.

In the past, to determine whether security features were properly configured on each of several computers on a network, a network administrator had to manually verify the existence of current security patches and the proper security settings or configuration for each computer on the network. Alternatively, the network administrator could supply instructions to each user on the network, and entrust that those instructions would be followed.

More recently, Microsoft Corporation has offered a tool called Microsoft® Baseline Security Analyzer (“MBSA”). In summary, MBSA is an executable that can be downloaded onto a computer and that may be run to verify that the latest security patches are available on that computer, and that security settings are set according to security best practices. MBSA may also be used on one computer to verify security configurations on computers that are linked to that computer via the network.

To determine if a specific patch is installed on a given computer, MSBA evaluates three items: the registry key that is installed by the patch, the file version of the patch, and the check sum for each file that is installed by the patch. All of this information is available to a remote computer via public application programming interfaces (APIs). To determine which patches should be available on the computer, MSBA uses the HFNetCHK tool to identify if the security updates have been applied to the system. This tool refers to an extensible mark-up language (“XML”) security hot-fix database which is constantly updated by Microsoft Corporation to determine currently released security updates.

In addition to confirming or checking the existence of current security patches, MBSA scans for security configurations in the Windows® operating systems, such as “Guest” account status, file system type, available file shares, members of the administrators group, simple passwords, and so forth. After reviewing the patches and conducting the operating system check, the MBSA provides, through a user interface tied with its executable, a security report with instructions on fixing any issues found.

While the MBSA works well for its intended purpose, there are some shortcomings to its implementation and use. For example, in order to check the status of a computer network, the computer being checked must be turned on and must be connected to the network at the time of the test. In addition, while HFNetCHK provides access to the latest patches that may be available for a computer, other tests, such as security configuration checks for the Windows® operating systems, may be updated only by updating the MSBA software.

### SUMMARY OF THE INVENTION

The present invention provides a system and method of verifying security best practices on a computer or for multiple computers on a network. The system includes a master test engine that may be provided on a single computer and which drives a verification process for the single computer, or for multiple computers. The master test engine accesses a primary manifest data file which describes verification tests to be performed by each of the computers to be tested. The primary manifest data file may include schema for all possible tests that may be run for computers, and may maintain a computer-specific list of tests for each computer that is to be tested.

To execute the tests within the primary manifest data file, one or more test executables are created. The text executables are run by local test engines which are located on each one of the computers on which tests are conducted. The local test engines drive the security tests on the computers, and access locally stored manifest data files, which are created and updated by the master test engine as dictated by the primary manifest data file. The local data manifest files may be updated, for example, via synchronization or by the master test engine pushing new data from the primary manifest data file to the local manifest data files.

The local test engine may instruct the test executables to run tests as a result of polling from the master test engine, or the local data manifests may include information which causes tests to be exceptions based (e.g., based upon a particular event or upon the passage of a particular amount of time). Operation of the test executables at a computer where a local test engine is located yields a results data file which describes the outcome of the test. The results data file is a portable file, for example, an XML document, which may be reviewed on the local machine, forwarded back to the master test engine, or may be exported to a third party that is monitoring the security practices of the computer. If forwarded to the master test engine, two or more results files may be combined to form a combined test report, which may also be an XML document.

The master test engine exposes a number of private application programming interfaces (“APIs”) to add and enumerate available tests, to turn tests on or off, and to run tests. Machine name may be added as a parameter in a call to the APIs so that one or more tests may be added or enumerated for a particular machine, or so that existing tests may be turned on or off for a particular machine.

The tests defined within the primary manifest data file may or may not be designated as being relevant to particular machines on the network. If desired, all tests may be provided to the local test engines so that local manifest data files include tests that are both relevant and not relevant to the individual computer. Alternatively, a more efficient process causes local manifest data files to include information that is relevant only to the particular computer associated with the local manifest data file.

The test system of the present invention provides a robust manner in which individual computers may run tests (e.g., via the local test engines) and generate results, either while connected to a network or when offline. The local and the global results files are portable, meaning that each of them may be forwarded to another computer or may be accessed by another program module (e.g., a viewer). By being portable, the files may be provided to the master test engine when connected to the network, or may be provided to another computer (e.g., the roote monitoring computer 206) without going through the master test engine.

Other advantages will become apparent from the following detailed description when taken in conjunction with the drawings, in which:

### BRIEF DESCRIPTION OF THE DRAWINGS

FIG. 1 is a block diagram representing a computer system into which the present invention may be incorporated;

FIG. 2 is a block diagram of a network in which the present invention may be incorporated;

FIG. 3 is an architecture of a test system incorporating the present invention;

FIG. 4 is a block representation of a schema that may be used for a primary data manifest for the test system of FIG. 3;

FIG. 5 is a block representation of an alternate embodiment of a schema that may be used for a primary data manifest for the test system of FIG. 3;

FIG. 6 is a block representation of a schema that may be used for a local data manifest for the test system of FIG. 3;

FIG. 7 is a block representation of a schema that may be used for a local results file for the test system of FIG. 3;

FIG. 8 is a block representation of a schema that may be used for a global results file for the test system of FIG. 3;

FIG. 9 is a flow diagram generally representing exemplary steps for updating a local data manifest for the test system of FIG. 3 in accordance with one aspect of the present invention; and

FIG. 10 is a flow diagram generally representing exemplary steps for running tests in a local data manifest for the test system of FIG. 3 in accordance with one aspect of the present invention.

### DETAILED DESCRIPTION

Exemplary Operating Environment

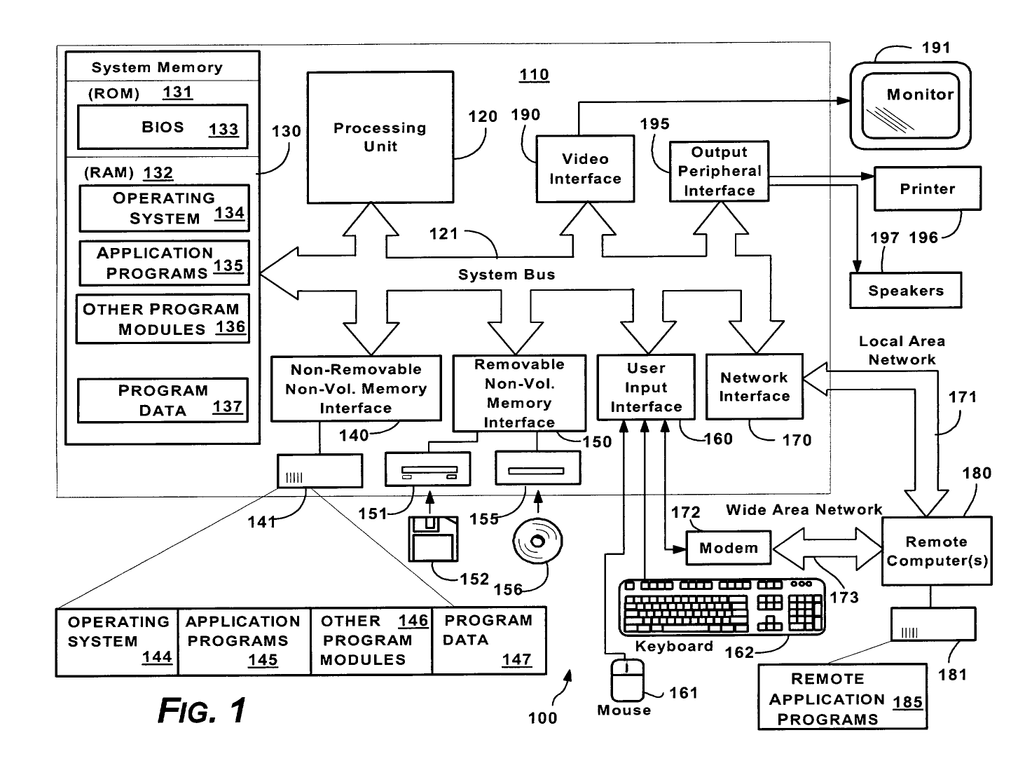

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microcontroller-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the invention includes a general-purpose computing device in the form of a computer 110. Components of the computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer-readable media. Computer-readable media can be any available media that can be accessed by the computer 110 and includes both volatile and nonvolatile media, and removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 110. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media, discussed above and illustrated in FIG. 1, provide storage of computer-readable instructions, data structures, program modules, and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers herein to illustrate that, at a minimum, they are different copies. A user may enter commands and information into the computer 20 through input devices such as a keyboard 162 and pointing device 161, commonly referred to as a mouse, trackball, or touch pad. Other input devices (not shown) may include a microphone, joystick, game pad, satellite dish, scanner, a touch-sensitive screen of a handheld PC or other writing tablet, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

System for Verifying Security Best Practices

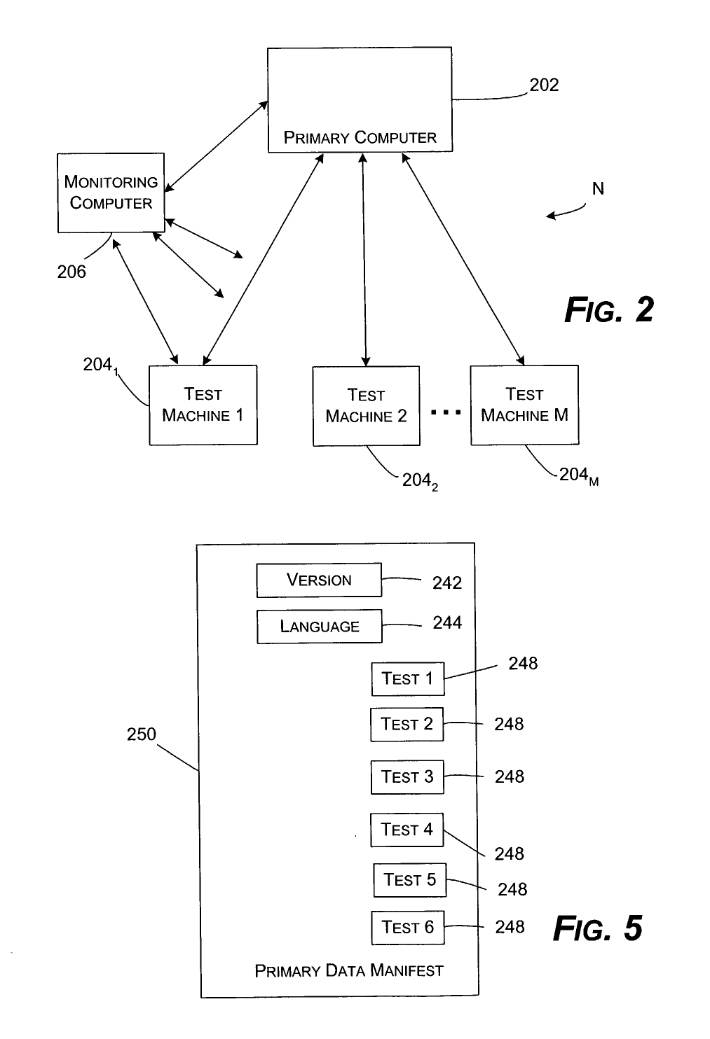

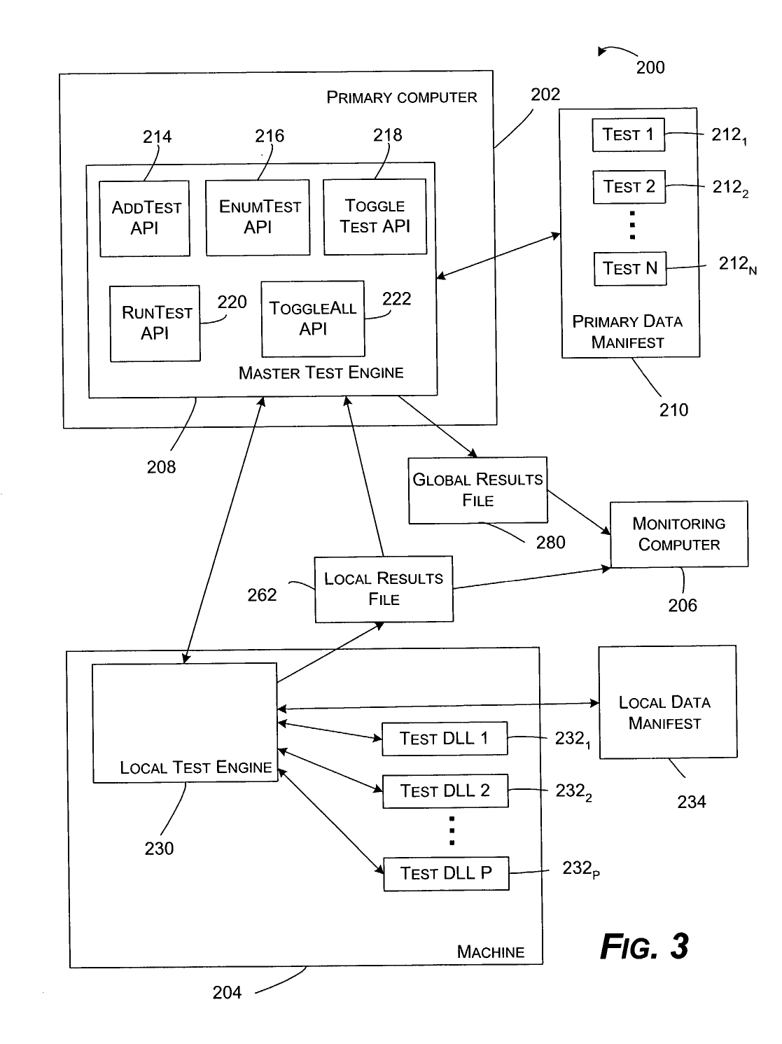

FIG. 2 shows a block diagram of a network N in which a test system 200 (FIG. 3) of the present invention may be incorporated. Briefly described, the test system 200 is configured so that a primary computer 202 (e.g., the computer 110) may monitor the security practices of itself and/or one of many machines 204₁, 204₂, 204₃ . . . 204ₘ (e.g., each of which is similar to the remote computer 180). As further described below, in accordance with one aspect of the present invention, tests are run on one or more of the machines 204, and perhaps on the primary computer 202. The results of the tests conducted on test machines 204 and/or the primary computer 202 may be reported in a test results file which may be accessed and displayed, for example, by the primary computer 202, one of the machines 204₁-204ₘ, or by a monitoring computer 206, which may be remotely located or may be connected to the network N.

The network N may be, for example, a LAN (e.g., the LAN 171), a WAN (e.g., the WAN 173), or other networks. In addition, the functions and aspects of the present invention may be implemented in environments other than networks. For example, as further described below, the only computer to be monitored may be the primary computer 202, wherein the components and/or functions of the primary computer and one of the machines 204 may be associated with the primary computer.

The primary computer 202 may be a primary or other server in a distributed server network, a client in a server network, or a computer in a peer to peer network. In addition, although the primary computer 202 may be connected to the machines 204 while tests are conducted, in accordance with one aspect of the present invention and as further described below, the system 200 is configured to run tests regarding the security practices of the machines 204 whether they are connected to the primary computer 202 or not.

Turning now to FIG. 3, the primary computer 202 includes a master test engine 208 associated therewith. The elements or components of the master test engine 208 may be included entirely on the primary computer 202, or may be distributed over a number of computers, or two or more of the elements of the master test engine 208 may be combined to form a single component, or the functions of the many components may be spread over multiple elements on the same machine or on multiple machines. However, for ease of description, in the described embodiment the master test engine 208 is assumed to reside on the primary computer 202.

A primary data manifest 210 is associated with the primary computer 202. The primary data manifest 210 may be stored on the primary computer 202, or may be associated therewith. The primary data manifest 210 is a file containing a descriptive list of available tests 212₁, 212₂ . . . 212ₙ, further discussed below.

In accordance with one aspect of the present invention, the master test engine 208 includes five new application programming interfaces (API's): The AddTest API 214, the EnumerateTest API 216, the ToggleTest API 218, the ToggleAll API 220, and the RunTests API 222. The function and operation of each of these APIs are further described below.

For ease of description, only one machine 204 is shown and is described with reference to FIG. 3. However, some or all of the components for the machine 204 described with reference to FIG. 3 may be present on each of the machines 204₁, 204₂ . . . 204ₘ in FIG. 2. Moreover, if desired, the elements of the master test engine 208 and components that are described as being available on the machine 204 may be included on one machine (e.g., the primary computer 202) for monitoring the security practices of that machine. However, again for ease of description, the components for the machine 204 are described as being located on the machine 204.

The machine 204 shown in FIG. 3 includes a local test engine 230 for conducting tests on the machine. A plurality of test executables 232₁, 232₂ . . . 232_{P} are present on the machine 204 or are otherwise associated with the local test engine 230. The test executables 232 may be, for example, dynamic link libraries (DLLs) that are configured to run tests requested by the local test engine 230. A local data manifest 234 is also associated with the machine 204, and may be stored thereon or may otherwise be associated with the local test engine 230.

Turning now to FIG. 4, a schema 240 that may be used for the primary data manifest 210 is shown. In general, the primary data manifest 210 is a file containing a descriptive list of tests that are available to be run on the machine 204. As such, the schema may include information about tests. The information may be stored as a master list, as lists for particular computers, or both. In addition, metadata may be associated with the schema, such as language or version information. Also, if desired, additional information may be stored with each list entry, such as information about when the test is to be run.

For example, the schema 240 shown in FIG. 4 includes version information 242, language information 244, or similar metadata. In addition, in accordance with one embodiment of the present invention, the schema 240 includes a listing 246 for each machine that the master test engine 208 is monitoring. Each machine listing 246 includes one or more tests 248 associated therewith.

An example of the schema that may be used for the primary data manifest 210 is set forth below.

<SBSSecTestManifest

SBSVersion=“host product version number”
SBSLang=“file language”
ManifestVersion=“file format version number”>
<Machines>

<Machine>

Name=“computer identifier”
State=“whether any tests are to be run on this

machine”

<Tests>

<Test

InternalName=“unlocalized test name”
ProgID=“test executable COM program

identifier”

Version=“test executable version”
Lang=“test executable language”
UIName=“localized test name for display”
Description=“localized test description

for display”

State=“whether test is to be run or not”/>

</Tests>

</Machine>

</Machines>

</SBSSecTestManifest>

The above example lists only machine and one test for that machine, but the primary data manifest 210 may list many machines with one or more tests for each. Version and language information is listed for the primary data manifest 210. The machine is listed by an identifier, which may be, for example, a computer name or a GUID that is associated with the machine. Also, for each machine, there may be an attribute called “state” which lists whether or not tests are to be run on the particular machine. Similarly, for each test on a machine, there is a state attribute which stores information about whether a test is to be run.

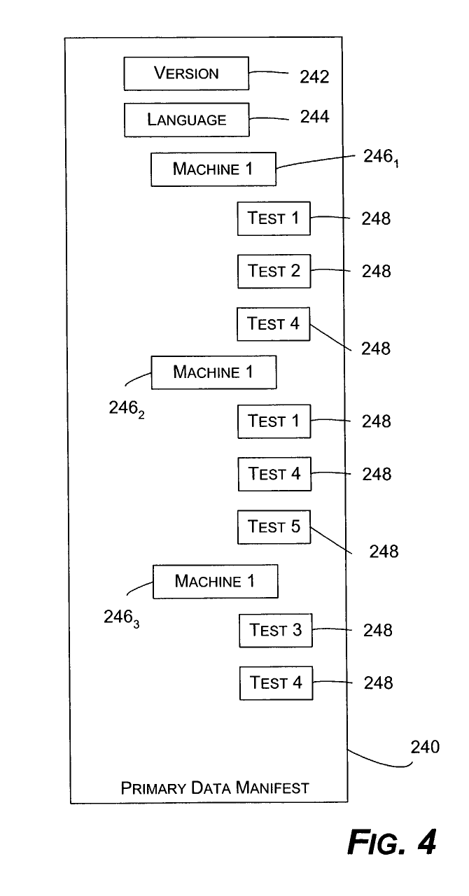

An alternate embodiment of the schema 250 that may be used for the primary data manifest 210 is shown in FIG. 5. The alternate schema 250 includes similar version and language information 242 and 244. However, instead of having tests listed with particular machines, lists all available tests without association with specific machines.

The master test engine 208 maintains the primary data manifest 210. It may use WINDOWS UPDATE, for example, to keep an updated list of security patches that are available for computers that utilize WINDOWS operating systems. Also, in accordance with one aspect of the present invention, the master test engine exposes the AddTest API 214 that permits authorized caller to add tests to the primary data manifest 210. If desired, a machine name may be added as a parameter to the call, so that the test or tests added are specific to a machine. Otherwise, tests may be added on a global basis. For example, a test may be added on a global basis that requests a check to see if a particular security patch has been added to each of the computers. Alternatively, a software company may provide a check for a particular security setting for its software.

The tests that are added are executables, such as a DLL. The executables are stored in the primary data manifest 210 and accessed and used accordingly (explained further below). The master test engine 208 may, for example, use private object classes to manipulate the primary data manifest 210. These private object classes may read, edit, and write the XML structures and data in the primary data manifest 210.

The master test engine 208 also exposes the EnumerateTest API 216, which allows an authorized caller to enable display of the available tests in a user interface, or to support scripting the system (automating its execution). Again, this call may include a machine name as a parameter so that the tests listed for a particular machine may be returned.

The ToggleTest API 218, also exposed by the master test engine 208, allows an authorized caller to turn an individual test on or off. The ToggleAll API 220 allows an authorized caller to turn all tests on or off. Again, one or more machine names may be added as a parameter to either of these calls.

The master test engine 208 uses the information in the primary data manifest 210 to generate a local data manifest 234 for local test engine 230 of the machine 204. Alternatively, the master test engine 208 may provide access for the local test engine 230 to the primary data manifest 234 so that the local test engine 230 may create a local data manifest 234. The local data manifest 234 includes information about tests to be run on the machine 204. If the primary data manifest 210 utilizes the schema 240 shown in FIG. 4, the machine 204 may be run the tests that are specific to the machine, for example, by the master test engine 208 extracting or copying the tests that are listed for that specific machine in the machine listings 246 portion of the schema 240. Alternatively, if the schema 250 shown in FIG. 5 is used, the master test engine 208 may query the local test engine about its system and provide relevant tests. As yet other alternatives, the tests for all machines may be provided to the machine 204, or a query by the local test engine 230 may request tests only for the configuration of the machine 204.

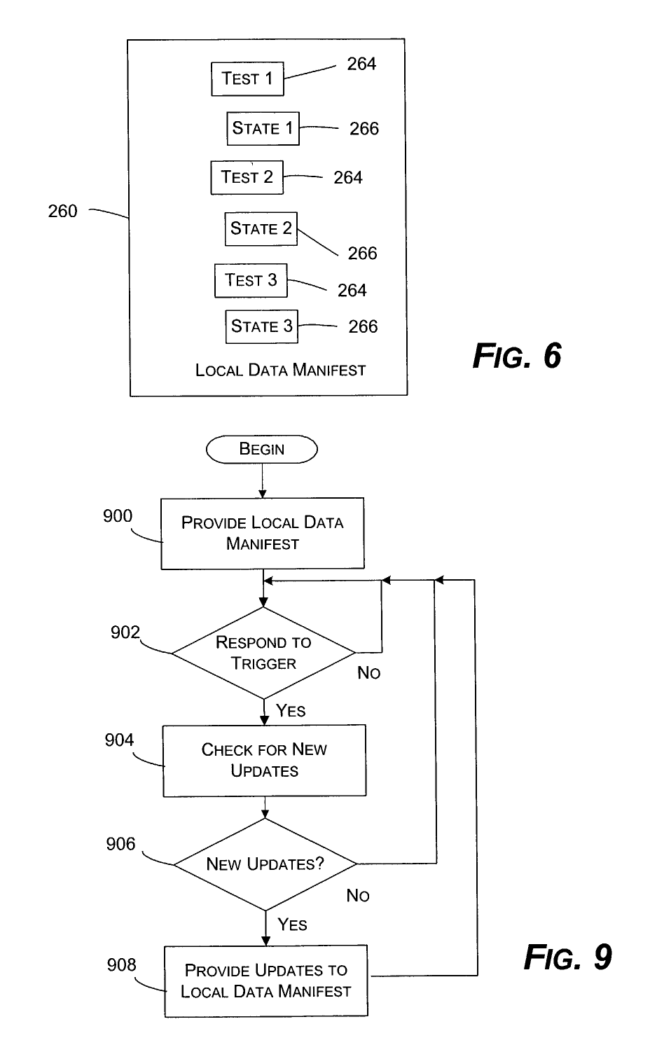

In either event, a local data manifest 234 is associated with the machine 204 and includes information about the tests that are to be run on the machine. An example of a schema 260 for the local data manifest 234 is shown in FIG. 6. The schema 260 includes a list of the tests 264 to be run on that machine 204. Also, the schema 260 for the local data manifest 234 includes the information about when tests are to be run on the local machine 204, such as in the form of states 266.

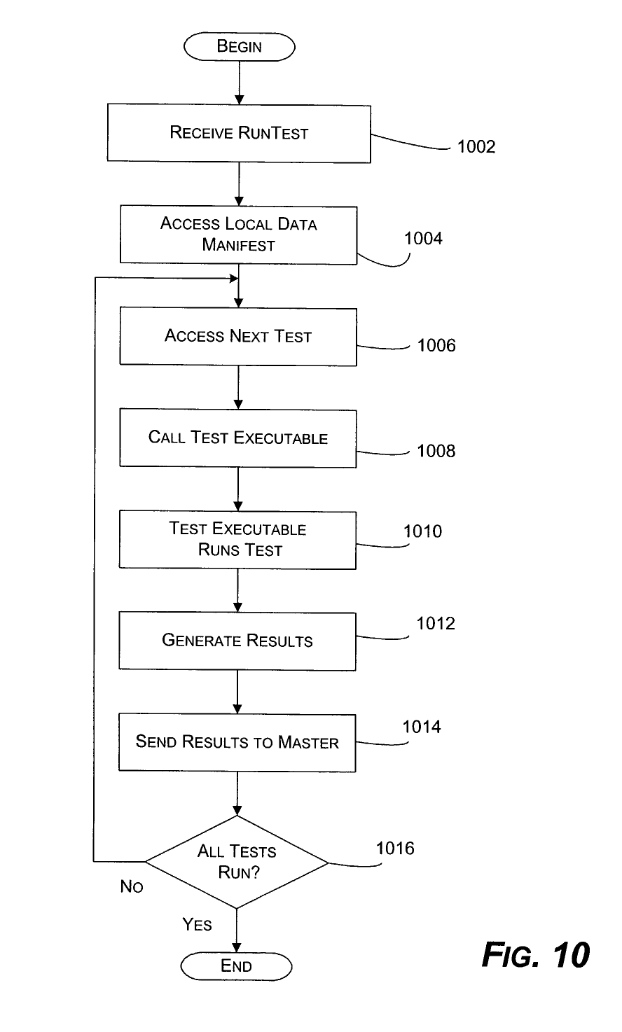

Preferably, the local data manifest 234 is kept current by regular interactions with the primary data manifest 210. FIG. 9 is a flow diagram generally representing exemplary steps for updating a local data manifest 234 in accordance with one embodiment of the present invention. Beginning at step 900, the local data manifest 234 is initially created, for example by downloading information from the primary data manifest 210. At step 902, a determination is made whether should check for new tests that may be available to run on the machine 204. Effectively, the requests are performed in response to a trigger, which may be one of several different ways. For example, the local test engine 230 may regularly request or ping the master test engine 208 for changes to a manifest associated with the machine 204, for example prior to execution. Alternatively, changes to the manifest may be pushed to the local test engine 230 for storing in the local data manifest 234 when the changes occur. In addition, the trigger may be a user logging onto a computer, or a particular event happening on the computer.

In any event, if the time for receiving an update has not occurred, then the process loops back until it does occur. If it has occurred, then step 902 branches to step 904, where a check for new updates occurs. If there are not new updates, then step 906 branches back to step 902, where the process awaits the next time for a check.

If there are new updates, then step 906 branches to step 908, where these updates are provided to the local data manifest 234. The process then loops back to step 902 to await the time for a new update.

New updates to the primary data manifest 210 may occur, for example, when an authorized caller adds one or more tests to the primary data manifest 210 via the AddTest API 214. Alternatively, new tests may be added as a result of updates to a hot fix database that may be constantly in communication with the primary data manifest 210.

The local test engine 230 is an executable program that is responsible for running tests on the machine 204. The local test engine 230 receives a list of tests to be run, in the form of the local data manifest 234, from the master test engine 208 or otherwise, as described above. When a test is to be run (e.g., because of a call to the RunTest API 220 or due to a schedule), the local test engine 230 launches the test's executable program.

The function performed by a test executable 232 depends upon the test being run. For example, a test executable 232 may simply read a registry value in the operating system of the machine 204. Alternatively, the test executable 232 may use a management system to access information, such as Microsoft Corporation's Windows Management Instrumentation (WMI) technology. Microsoft Corporation's Windows Management Instrumentation technology includes an extension of the Common Information Model (CIM) for Microsoft Corporation's Windows Operating Systems platforms. However, although embodiments of the present invention may be described in cooperation with the WMI management system, the present invention may utilize other management systems. Thus, reference here to the WMI management system is for illustrative purposes only and does not limit the applicability of the invention.

Some examples of tests are given for the benefit of the reader. The examples given are not meant to be limiting, but instead are meant to provide some illustrations of tests that might be run by the test executables. As one example, a test executable 232 may verify that the machine's password policy requires character complexity, such as punctuation, capitals, and numbers, in order to increase the difficulty of guessing a password. As another example, a test executable 232 may verify that the machine's password policy requires a password length of over 7 characters, in order to increase the difficulty of guessing a password. Still another test executable 232 may provide a list of the machine's administrator accounts, to be reviewed by an authority, thus preventing unwelcome machine administrators. A test executable 232 may also verify that automatic logon (i.e., logon without password) is not enabled on a computer, or may otherwise verify safe logon requirements. Another test executable 232 may verify that logon events are audited by a server to determine whether unauthorized users are trying to gain access. Shared folders may be listed by another test executable 232. Other tests may be performed depending upon the desired verification.

Because the test executables 232 are executable files, they may also access parts of applications, programs, or an operating system that are not typically accessible by a management system. In fact, because authorized software developers may provide tests through the AddTest API 214, those software developers may build security verification tests for various features of their software. The tests may be published to any network where the invention exists, and revisions to the tests or additional tests may be provided to the primary data manifest 210 via additional calls to the AddTest API 214, for example by synchronization.

In accordance with one aspect of the present invention, after tests are run on the machine 204, a local results file 262 (FIG. 7) is generated for the test by the local test machine 230. The local results file 262 may be, for example, an extendable markup language (XML) file. In the embodiment shown in FIG. 7, the local results file 262 includes information about the machine, such as a computer identifier 280, information 272 about the test, a timestamp 274 that includes information about when the test was conducted, and the results 276 of the test. The results of the test may be the answer to a yes or no question, a value, a string, or other suitable relevant information that indicates the outcome of the test.

A local results file (e.g., the local results file 262) may include information about only one test that has been conducted, or may include information regarding multiple tests. In addition, a local results file may include multiple results of the same test.

In accordance with an aspect of the present invention, the local results file 262 is in a portable data format, such as XML. This permits the results file to be viewed by one of many different available public APIs. If XML is used, the file can be programmatically read and displayed accordingly to XML APIs published at the Microsoft Developer's Network (MSDN) which can be found at http://www.msdn.microsoft.com. As one example, the local results file 262 may be sent to the monitoring computer 206, as shown in FIG. 3.

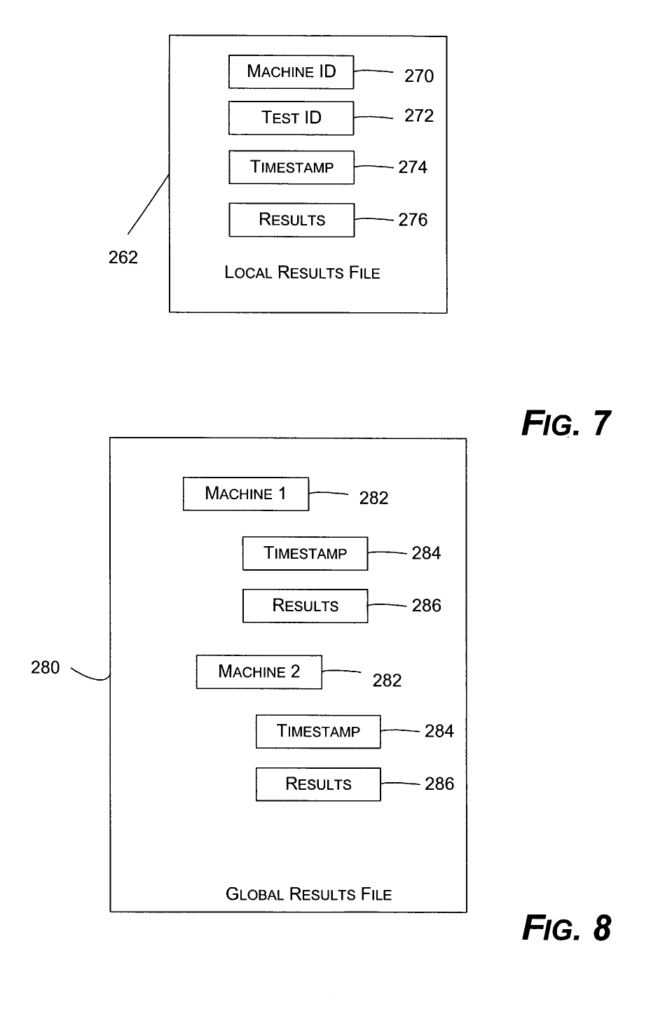

The local results file 262 may also be sent to the master test engine 208, which may package that local results file 262 with information in other local results files to create a global results file 280, shown in FIG. 8. The global results file 280 is similar in structure to the local results file 262, but includes numerous test results. As one example shown in FIG. 8, results of one test that was conducted on multiple computers are generated in a report. In the example shown, the global results file 262 includes information 282 about the machine on which the test was run, a timestamp 284 of the test, and the results 286 of the test on that machine. Additional information, for example, the version of the test conducted, or conditions of the tests, may be included.

The global results file 280 may include information as desired by a programmer. In addition, the information within the global results file may be stored in an accessible and viewable format, such as XML, so that an administrator or a third party vendor may access the information for viewing or other uses.

FIG. 10 is a flow diagram generally representing exemplary steps for running tests in a local data manifest 234 on the machine 204. Beginning at step 1002, the local test engine 230 receives a request to run all tests on the machine. This request may be a result of an authorized caller requesting via the RunTest API 222 that the master test engine 208 run tests on all machines. Alternatively, the authorized caller may request, with the machine name as a parameter, that the particular machine 204 have all tests run. As an alternative to step 1002, an exception-based test may cause the local test engine 230 to begin a test because of the occurrence of an event or based upon a schedule.

In any event, at step 1004 the local test engine 230 accesses the local data manifest 234 to determine which tests are to be run. This may be determined via the state that is defined for the test and/or as a result of the RunTest API 222 being called.

At step 1006, the local test engine 230 accesses the next test, in this case the first test. At step 1008, the appropriate test executable 232 is called by the local test engine 230, where the test is run (step 1010). After the test is run, results are generated at step 1012. These results are published to a local results file 262. The local results file 262 may then be sent, for example, to the master test engine 208, for adding to a global results file 280. Alternatively, the local results file 262 may be sent directly to a monitoring computer 206, which may read the results file and act accordingly (e.g., ignore, or send a warning communication to an administrator or to the user of the machine 204).

At step 1016, a determination is made whether all tests in the local data manifest 234 have been run. If not, the process loops back to step 1006, where the next test in the local data manifest 234 is accessed. If so, then the process ends.

The present invention provides many enhanced features for monitoring security best practices. For example, because an executable is located at each machine 204, tests may be run while a machine is connected to the network or when the machine is offline. The results of the test, in the form of the local results file 262 may be sent when the computer is back online. In addition, because the local results files 262 and 280 are portable files, these files may be read at the primary computer 202, at any of the machines 204, at the monitoring computer 206, or by any other authorized computer. If the schema for the results file is produced in an easily accessible language like XML, the final results file can be programmatically read and displayed according to published APIs.

The fact that the results are portable also permits onsite or remote monitoring of the security practices of a network. As one example, an administrator on a network may monitor the results. As another example, the local results file 262 or the global results file 280 may be forwarded to a vendor that is not connected to the network and that provides maintenance and monitoring services for a network. The vendor may use the results file in many ways, for example, may generate a solution that may be emailed or otherwise sent to a client.

The APIs 214, 216, 218, 220 permit authors and managers of arbitrary software applications and systems to build security verification tests for their software and provide these security tests to the primary data manifest 210. In addition, the software authors or administrators may access the primary data manifest to turn on or off tests for a specific computer or all computers. The AddTest API 214 permits the software author to synchronize the latest version of security verification tests with the primary data manifest 210.

Other variations are within the spirit of the present invention. Thus, while the invention is susceptible to various modifications and alternative constructions, a certain illustrated embodiment thereof is shown in the drawings and has been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

What is claimed is:

1. A computer system, comprising:
a plurality of computers;
a master test engine configured to request that a test be conducted regarding a security practice of the plurality of computers; and
a plurality of local test engines, at least one each associated with each the plurality of computers, each of the local test engines being configured to conduct the test.

2. The computer system of claim 1, wherein each of the local test engines is configured to conduct the test by executing a test executable associated with the test.

3. The computer system of claim 2, further comprising a plurality of local data manifests, at least one each associated with each of the plurality of computers, and each having information regarding the test therein, the information being supplied by the master test engine.

4. The computer system of claim 3, wherein each of the local test engines is configured to conduct the test by accessing the local data manifest.

5. The computer system of claim 1, further comprising a plurality of local data manifests, at least one each associated with each of the plurality of computers, and each having information regarding the test therein, the information being supplied by the master test engine.

6. The computer system of claim 5, wherein each of the local test engines is configured to conduct the test by accessing the local data manifest.

7. The computer system of claim 1, further comprising a primary data manifest associated with the master test engine and having information about the test therein, and wherein the master test engine is configured to request that the test be conducted by accessing the information about the test.

8. The computer system of claim 7, wherein the master test engine is configured to request that the test be conducted by providing the information about the test to the plurality of computers.

9. The computer system of claim 1, further comprising a plurality of local data manifests, at least one each associated with each of the plurality of computers, and each having information regarding the test therein, the information being supplied by the primary data manifest.

10. The computer system of claim 1, wherein each of the local test engines is configured to generate a portable local test result file describing a result of the test.

11. The computer system of claim 10, wherein each of the local test engines is configured to forward its respective local test result file to the master test engine.

12. The computer system of claim 11, wherein the master test engine is configured to generate a portable global test file from information in each local test result file.

13. The computer system of claim 10, wherein the master test engine is configured to generate a portable global test file from information in each local test result file.

14. A computer-readable medium having computer-executable instructions comprising:
accessing a test to be run to verify a security practice on a computer;
executing the test on the computer to create a result; and
creating a portable results file including the result.

15. The computer-readable medium of claim 14, wherein the portable results file comprises an XML file.

16. The computer-readable medium of claim 14, wherein accessing a test comprises accessing a local data manifest.

17. The computer-readable medium of claim 14, wherein executing the test on the computer comprises executing a test executable associated with the test.

18. The computer-readable medium of claim 14, having further computer executable instructions for forwarding the portable results file to a remote computer.

19. A method verifying security practices for a plurality of computers, comprising:
maintaining information in a data manifest about tests for verifying the security practices of the plurality of computers;
providing tests for verifying the security practices to the plurality of computers based upon the information;
receiving a call to update the information in the data manifest; and
updating the information in the data manifest in accordance with the call.

20. The method of claim 19, further comprising:
maintaining information in the data manifest about specific tests to be conducted on each of the plurality of computers; and
receiving a call to update the information in the data manifest for a particular computer; and
updating the information for the particular computer in accordance with the call.

21. The method of claim 19, further comprising:
receiving a call to turn off a test in the data manifest; and
not providing the test in response to the call.

22. The method of claim 19, further comprising:
receiving a call to turn off all tests in the data manifest; and
not providing the tests in response to the call.
